(19) United States
(12) Patent Application Publication
(10) Pub. No.: US 2008/0099584 A1
(43) Pub. Date: May 1, 2008

(54) Drip Irrigation pipe

(75) Inventor: Moshe Raanan, Hanegev (IL)

Correspondence Address: Gary M. Nath;THE NATH LAW GROUP, 112 South West Street, Alexandria, VA, 22314, US

(73) Assignee: NETAFIM LTD., Tel-Aviv (IL)

(21) Appl. No.: 11/976,119

(22) Filed: Oct. 22, 2007

Related U.S. Application Data
(62) Division of application No. 10/932,324, filed on Sep. 2, 2004.

(51) Int. Cl. B05B 15/00

(52) U.S. Cl. 239/547; 239/542; 264/563

(57) ABSTRACT

Drip irrigation pipe comprises drip irrigation emitter units bonded thereto, the pipe being made of water-impervious material and having foamed closed-cells therein. The drip irrigation pipe may be used in a piping package comprising also a spool. The length of the pipe and the number of the emitter units in the package are greater than those which the package of the same weight with the same spool would have, if the pipe was made of the same material but not foamed, and had the same outer diameter and about the same thickness.

### FIELD OF THE INVENTION

This invention relates to drip irrigation pipe and manufacturing thereof.

### BACKGROUND OF THE INVENTION

A drip irrigation pipe, apparatus and process for producing drip irrigation pipe similar to the kind to which the present invention is directed, is described in U.S. Pat. No. 5,324,371 which discloses a method and installation for producing a drip irrigation pipe having discrete drippers or emitters bonded to the internal side of the pipe at axially spaced apart locations by a continual extrusion method.

U.S. Pat. No. 4,577,998 (Dorm) discloses a process for producing a flexible PVC irrigation pipe by extruding a plasticized PVC composition containing a melt strength-enhancing aid and a chemical blowing agent.

### SUMMARY OF THE INVENTION

There is provided according to the present invention a novel drip irrigation pipe and possible apparatus and method for producing the pipe, as well as a novel piping package.

The drip irrigation pipe of the present invention comprises a foamed plastic pipe body with irrigation emitter units internally bonded thereto. The foamed plastic pipe is of a closed-cell type and is made of a material impervious to water. Typically, the emitter units are discrete and bonded at an internal surface of the pipe at axially spaced apart locations.

The term “irrigation emitter unit(s)” is herein the specification used in its broadest sense and includes drippers, emitters and any other type of irrigation pipe fixture that can be incorporated in the pipe.

The term “closed-cell” when applied to a foamed plastic pipe means that at least a predominance of cells in the foamed plastic are closed.

The piping package according to the present invention, having a weight W, comprises: a spool and irrigation pipe rolled thereon and having walls of a thickness t and outer diameter OD, the pipe being made of a closed cell type foamed plastic material and having irrigation emitter units bonded to said walls at predetermined spacing one from another; the total number of said irrigation emitter units in said pipe being greater, typically at least 10% greater, than it would be if the pipe was made of the same plastic material that is not foamed, had the same spacing between its irrigation emitter units, had the same outer diameter OD, had a thickness not exceeding said thickness t and the package had the same weight W.

According to the present invention, an apparatus for manufacturing a drip irrigation pipe comprises:
an extruder designed for receiving a plastic material that is capable of forming a closed-cell type foamed pipe under foaming process conditions that is impervious to water, and extruding said plastic material to obtain a molten plastic;
an extrusion cross head receiving said molten plastic from said extruder and in turn extruding it through a die to form an extruded pipe;
a calibrator unit for receiving an extruded pipe from the cross head and reducing the diameter of said extruded pipe, the unit being spaced from said extruder cross head by an intermediate distance;
a process control system capable of controlling said process conditions so as to ensure that closed cells are formed in said molten plastic and that said extruded pipe entering the calibrator unit is thus a foamed extruded pipe with said closed cells;
a drawing-off mechanism located downstream of said calibrator unit for drawing said foamed extruded pipe through and out of the calibrator unit;
an elongated emitter carrier element for supporting irrigation emitter units for successive movement along its length;
an emitter feed mechanism for successively feeding said emitter units into supported relationship with said carrier element; and
an emitter displacement arrangement for successively accelerating said emitter units along said carrier element and into contact with said foamed extruded pipe when the latter has substantially attained its reduced diameter.

According to the present invention, a method for producing a drip irrigation pipe comprises:
extruding in an extruder apparatus either a plastic material incorporating closed cells or a foaming agent or a combination thereof, or a plastic material capable of being foamed by injecting a gas into the extruded plastic;
introducing said plastic material into a cross head;
operating said extruder and/or said cross head at processing conditions appropriate to said plastic material whereby a closed-cell type foamed plastic pipe is formed; and

introducing irrigation emitter units at axially spaced-apart locations along the pipe while the plastic material of the pipe is in a semi-molten state.

In the case where a foaming agent is added to the plastic material, it may be added prior to when the plastic material is fed to the extruder, or it may be added to the plastic material during the extruding thereof.

According to one embodiment of the present invention the plastic material incorporates a chemical foaming agent and the process further comprises inducing the foaming agent to form closed-cells in the pipe. The inducing entails providing the appropriate processing conditions to react the chemical foaming agent. Such a foaming agent can be either one that reacts to form a compound that is, or becomes, a gas at said conditions or it is one that changes its original non-gaseous phase to the gaseous phase.

According to another embodiment of the present invention, production of the closed cells is accomplished by injecting a physical foaming agent (e.g. a super cooled fluid, gas), typically at high pressure, into the plastic material when it is in a molten or semi-molten state. According to yet another embodiment of the present invention, the plastic material used to form the drip receiving pipe of the present invention comprises closed-cells. (e.g. a foamed plastic, a plastic material comprising hollow spheres, etc.)

Advantages of the drip irrigation pipe of the present invention include that, due to the lesser amount of resin consumed in the production of such pipe, it is relatively light-weight, and the pipe is easy to handle (e.g. install/uninstall), store and ship, and as such more pipe can be rolled on a conventional spool of a standard weight.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a perspective view of a drip irrigation pipe according to one embodiment of the present invention;

FIG. 2 is a schematic view of an apparatus for producing the drip irrigation pipe of the present invention;

FIG. 3 is an enlarged longitudinal cross-sectional view of a portion of the apparatus of FIG. 2; and

FIG. 4 is a perspective view of a piping package according to another embodiment of the present invention.

### DETAILED DESCRIPTION OF THE INVENTION

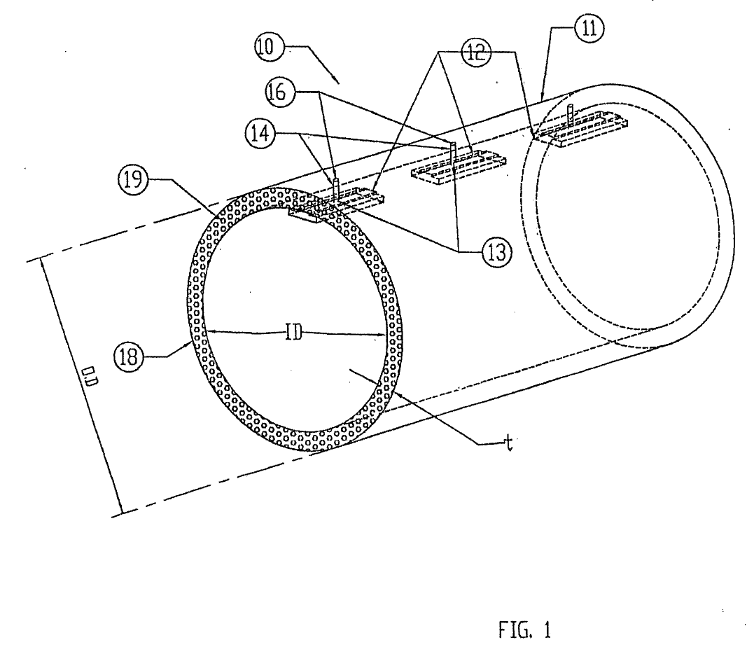

Referring first to FIG. 1 of the drawings, there is illustrated a portion of a foamed drip irrigation pipe 10 comprising a pipe body 11 and a plurality of irrigation emitter units 12 (e.g. drippers, emitters and the like) internally bonded thereto and designed to allow the passing of an irrigation fluid from the inside of the foamed pipe 10 to the outside; and for this purpose, each emitter comprises an inlet 13 and an outlet 14. In the embodiment shown in FIG. 1, the foamed pipe 10 comprises a small aperture 16 corresponding to the emitter's outlet 14—although the outlet could be flush with the outer surface of the pipe 10.

The foamed pipe 10 is made of a plastic material, typically, though not necessarily, a polyolefin, and further has therein closed-cells 18. The pipe 10 typically has annular shaped walls 19 (though other cross-sectional shapes are possible) of inner diameter ID, outer diameter OD and a thickness t.

The emitter units 12 are preferably bonded at spaced apart axial locations to an internal surface of the foamed pipe 10. The emitter units 12 can be of any known appropriate geometry and configuration, and are shown as non-cylindrical, elongated units with their elongated dimension corresponding to the longitudinal dimension of the foamed pipe 10, as illustrated in FIG. 1.

Emitter units used in the pipe of the present invention may be any suitable conventional emitter units, and, since their design is not part of the present invention, they will not be described herein in more detail.

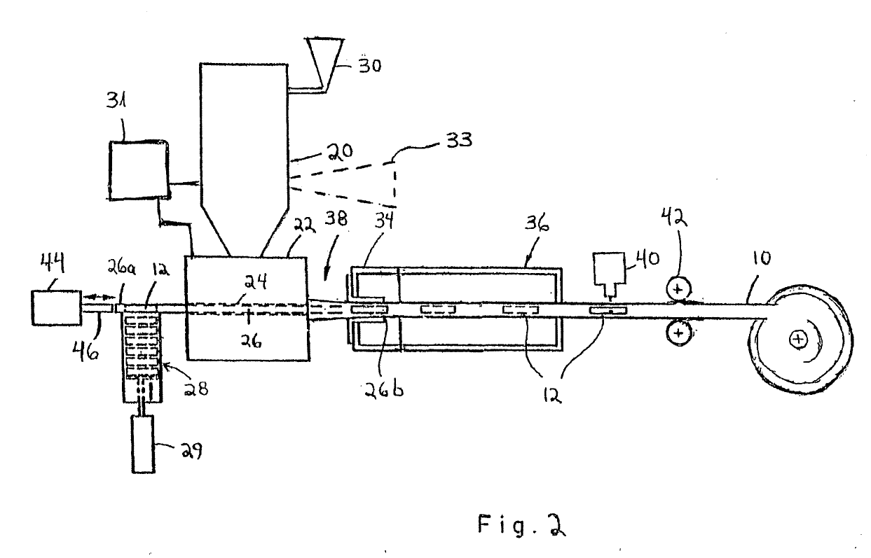

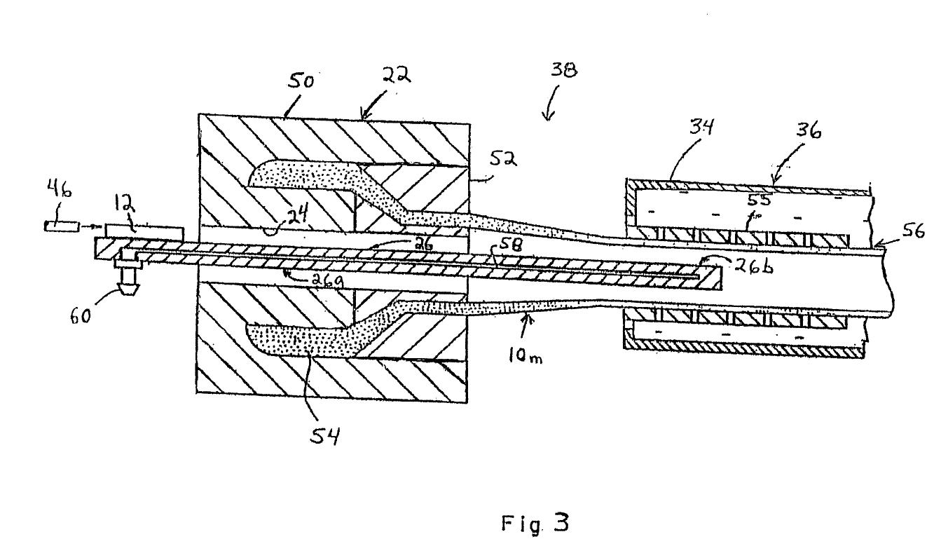

In FIG. 2 there is shown a schematic view of an apparatus for producing the foamed pipe 10. The apparatus comprises an extruder 20 provided with an extrusion cross head 22 having a coaxial bore 24 through which extends an elongated emitter carrier 26. An upstream end 26a of the carrier 26 is aligned with an emitter stack 28 from which emitter units 12 can be successively fed by an emitter feeding unit 29 onto the upstream end 26a of the carrier 26. Associated with the extruder 20 is a foaming agent feeder 30. The extruder 20 is designed to receive a plastic material and a foaming agent (not shown) from the foaming agent feeder 30 whereby there is formed a plastic mixture 54 (seen in FIG. 3). The apparatus further comprises a process controller 31 for controlling the process conditions of the pipe production.

Alternatively, foaming can be caused by injecting a physical foaming agent, mutatis mutandis, into the extruder 20 and for that purpose a foaming agent injector 33 (shown with dashed lines to indicate it as an option) should be associated with the extruder 20.

A calibration unit 34 along with a cooling unit 36 is located downstream from the extrusion cross head 22 and is spaced therefrom by an intermediate region 38. A downstream end 26b of the carrier 26 projects into the calibration unit 34. Downstream of the calibration unit 34 is the cooling unit 36 followed by a pipe aperturing station 40 and a drawing off mechanism 42 for drawing off the extruded foamed pipe 10.

An emitter displacement unit 44 is located upstream of the upstream end 26a of the carrier 26 and is provided with a pusher 46 aligned with the carrier 26. The pusher 46 can be, for example, mechanically, electro-mechanically, or hydraulically operated so as to displace the pusher 46 at a rate in accordance with operational requirements.

FIG. 3 provides more details of the extrusion cross head 22, the carrier 26 and the calibration unit 34 and cooling unit 36. The extrusion cross head 22 comprises a cylindrical sleeve 50 which is fitted with a die 52. The molten plastic mixture 54 (comprising a plastic material and a foaming agent, as mentioned above) is extruded through the die 52.

The calibration unit 34 and cooling unit 36 comprise an apertured calibrator tube 55 secured to the walls of the calibration unit 34. The cooling unit 38 are filled with cooling water under a vacuum.

The elongated carrier 26 extends through the coaxial bore 24 of the extrusion cross head 22, the intermediate region 38 and into an axial bore 56 of the calibrator tube 55. The elongated carrier 26 is formed with a pair of elongated ducts 58 which pass along the length of the carrier 26 and serve for the passage of cooling fluid fed via an inlet nipple 60. The carrier 26 and the emitter units 12 are typically formed with corresponding shapes so as to support and align the latter.

In operation, the extruder 20 receives a plastic material (not shown) and the feeder 30 feeds it a foaming agent (not shown) thereby producing the plastic mixture 54.

From the extruder 20, the mixture 54 passes into the extrusion cross head 22 so as to emerge therefrom at a first linear velocity as an extruded, wide diameter molten pipe 10m.

Under the traction force exerted by the drawing-off mechanism 42 (FIG. 2), the foamed molten pipe 10m passes through the narrower opening of the calibrator tube 55 with the pipe's diameter and wall thickness being reduced substantially to their final dimensions and at a second and higher linear velocity. As the molten pipe 10m passes at this second linear velocity through the calibrator unit 34 and subsequent cooling unit 36 it cools down until it reaches its final set state with closed cells 18.

At the same time, successive emitter units 12 are fed onto the upstream end 26a of the carrier 26 and are displaced by the pusher 44 along the carrier 26 which serve to guide the emitter units 12, so as to be accelerated up to a linear velocity substantially corresponding to the second linear velocity of the pipe 10m until the upper surface of each successive emitter unit 12 contacts a spaced apart, inner surface location of the molten pipe 10m in the region of an inlet to the calibrator unit 34 and when the molten pipe 10m has substantially reached its second linear velocity. Each emitter unit 12 thus begins to become bonded to the inner surface of the molten pipe 10m as it is displaced along the carrier 26 at a linear velocity substantially equal to the second linear velocity of the molten pipe 10m until, by the time each emitter unit 12 reaches the end of the carrier 26, it is firmly bonded to the pipe.

The spacing apart of the emitter units 12 within the resultant pipe 10 is determined by time intervals between their successive displacements along the carrier 26.

Once the emitter units 12 have been firmly bonded to the molten pipe 10m and after the latter has emerged from the cooling unit 36, the location of the passing emitter unit 12 is sensed and the aperturing station 40 produces an aperture 16 in a position corresponding to the outlet 14 of the emitter unit 12. At this point the drip irrigation pipe is in the form of foamed drip irrigation pipe 10 as seen in FIG. 1.

Depending on the kind of plastic material and the foaming agent, process conditions are made in the extruder 20 and the cross head 22 suitable for producing of closed-cells in the plastic mixture such that the pipe entering the calibration unit 34 is a foamed pipe.

A variety of plastic material may be used to produce the foamed drip irrigation pipe 10 of the present invention—preferably those allowing the pipe to be stored in rolls and unrolled for installation—including typical thermoplastic plastics such as polystyrene, PVC, polyolefins (e.g. polyethylene and polypropylene) and ABS. As best as known there is no limitation to the type of foaming agent and those liberating carbon dioxide (e.g. carbonates or bicarbonates) or nitrogen (e.g. azo, hydrazo and nitroso organic compounds) should be suitable. The cross head 22 is typically heated to a temperature in the range of 220 to 250° C. The axial spacing of the emitter units may be easily varied by coordination of the velocity of the molten pipe being extruded and the frequency that the emitter units 12 are introduced therein; a typical range of spacing therebetween being about from 10-100 cm, and more typically 20-50 cm.

The foamed drip irrigation pipe 10 of the present invention may be produced by a process different from that described above. For example, such process may include taking a sheet or strip of closed cell foamed plastic bonding irrigation emitter units 12 thereto and welding the edges of the strip together to form a pipe, as disclosed e.g. in U.S. Pat. No. 4,247,051, U.S. Pat. No. 6,183,584, U.S. Pat. No. 6,464,816 and U.S. Pat. No. 6,561,443.

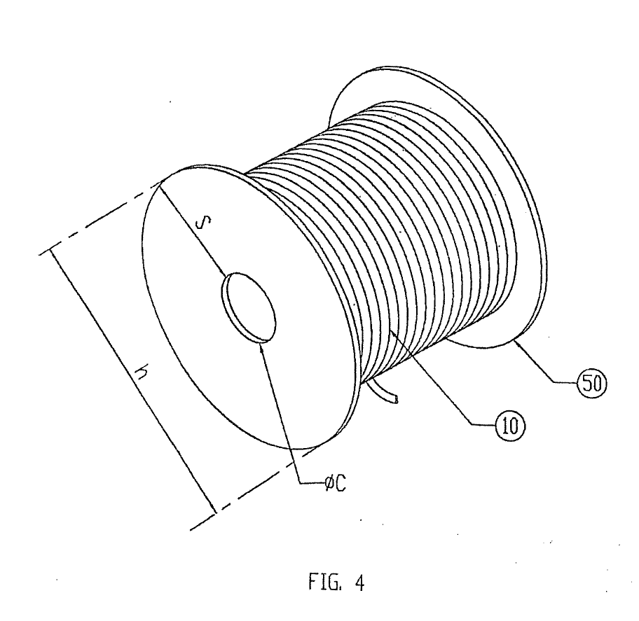

In FIG. 4 there is shown a piping package according to the present invention having a weight W and comprising a spool 50 and the foamed drip irrigation pipe 10. For this purpose the pipe 10 is adapted to be suitably flexible (i.e. rollable) for rolling/loading onto the spool 50. The spool 50 can be a conventional spool having a height h and a cylinder diameter c thereby defining a carry space dimension s wherein pipe can be rolled.

With reference to FIG. 1, the foamed plastic irrigation pipe 10 according to the present invention may have the same, or only a slightly greater wall thickness t than conventional irrigation pipe having otherwise the same parameters and made of a non-foamed material. However, the piping package 50 comprising a conventional spool and the foamed plastic irrigation pipe 10 of a predetermined weight may include a greater length of the pipe 10 of the present invention and greater number of irrigation emitter units 12 than a piping package comprising the conventional piping. The increase in the length and the number of irrigation emitter units of the present pipe is preferably at least 10%.

It will be appreciated by persons skilled in the art that the present invention is not limited by what has been particularly shown by the exemplary embodiments described hereinabove. Thus, the drip irrigation pipe and manufacturing thereof can be embodied by a variety of aspects within the scope of the invention, mutatis mutandis.

For example, instead of using a foaming agent, the closed cells in the foamed drip irrigation pipe 10 could be provided by using a plastic raw material that already incorporates closed cells or by a process whereby a gas (preferably an inert gas) is injected into the molten plastic during extrusion. It should be noted also that while examples of chemical foaming agents where given above, as best as known there is no preclusion to using a physical foaming agent, i.e. one that simply changes phase upon being heated to form a gas (e.g. a low boiling liquid such as a fluorocarbon).

Furthermore, the pipe walls 19 could be made of layers wherein one or more of those layers are foamed layers having closed cells therein, the apparatus and method being adapted, mutatis mutandis.

1-15. (canceled)

16. An apparatus for manufacturing drip irrigation pipe comprising:
an extruder designed for receiving a plastic material that is capable of forming a closed-cell type foamed pipe under foaming process conditions, the plastic material being impervious to water, and extruding said plastic material to obtain a molten plastic;
an extrusion cross head receiving said molten plastic from said extruder and in turn extruding it through a die to form an extruded pipe;
a calibrator unit for receiving an extruded pipe from the cross head and reducing the diameter of said extruded pipe, the unit being spaced from said extruder cross head by an intermediate distance;
a drawing-off mechanism located downstream of said calibrator unit for drawing said foamed extruded pipe through and out of the calibrator unit;
an elongated emitter carrier element for supporting irrigation emitter units for successive movement along its length;
an emitter feed mechanism for successively feeding said emitter units into supported relationship with said carrier element; and
an emitter displacement arrangement for successively accelerating said emitter units along said carrier element and into contact with said foamed extruded pipe when the latter has substantially attained its reduced diameter.

17. The apparatus according to claim 16, further comprising a foaming agent feeder associated with the extruder, the feeder adapted for introducing a chemical foaming agent into said extruder and said extruder is adapted to receive said chemical foaming agent.

18. The apparatus according to claim 16, further comprising a foaming agent injector associated with the extruder, the injector adapted for introducing a physical foaming agent into said extruder and said extruder is adapted to receive said physical foaming agent.

19. The apparatus according to claim 16, wherein said plastic material is a plastic material incorporating closed cells.

20. The apparatus according to claim 16, wherein the carrier element is provided with a cooling fluid transmission element.

21. The apparatus according to claim 16, further comprising an aperturing station for producing an aperture in the pipe at a location aligned with the outlet of the emitter unit.

22. The apparatus according to claim 16, further comprising a process control system capable of controlling said process conditions so as to ensure that closed cells are formed in said molten plastic and that said extruded pipe entering the calibrator unit is thus a foamed extruded pipe with said closed cells.

23. The apparatus according to claim 16, wherein the extrusion cross head comprises a bore through which extends the emitter carrier.

24. The apparatus according to claim 17, wherein the introduction of said chemical foaming agent entails providing appropriate processing conditions to react said agent.

25. The apparatus according to claim 24, wherein the reaction of the foaming agent forms a compound that is, or becomes, a gas.

26. The apparatus according to claim 24, wherein the reaction of the agent changes its original non-gaseous phase to the gaseous phase.

27. A method for manufacturing a drip irrigation pipe comprising:
extruding in an extruder apparatus either a plastic material incorporating closed cells or a foaming agent or a combination thereof, or a plastic material capable of being foamed by injecting a gas into the extruded plastic;
introducing said plastic material into a cross head;
operating said extruder and/or said cross head at processing conditions appropriate to said plastic material whereby a closed-cell type foamed plastic pipe is formed; and
introducing irrigation emitter units at axially spaced-apart locations along the pipe while the plastic material of the pipe is in a semi-molten state.
